(19) United States
(12) Patent Application Publication
(10) Pub. No.: US 2012/0224190 A1
(43) Pub. Date: Sep. 6, 2012

(54) Data Generating Apparatus, and Print Apparatus

(75) Inventors: Shigetaka YOSHIDA, Komaki-shi (JP); Kousuke FUKAYA, Chiryu-shi (JP); Kunihiko SAKURAI, Gifu-shi (JP)

(73) Assignee: BROTHER KOGYO KABUSHIKI KAISHA, Nagoya-shi (JP)

(21) Appl. No.: 13/471,243

(22) Filed: May 14, 2012

Related U.S. Application Data
(62) Division of application No. 11/679,578, filed on Feb. 27, 2007.

(30) Foreign Application Priority Data
Feb. 28, 2006 (JP) 2006-054201

(51) Int. Cl. G06K 15/02

(52) U.S. Cl. 358/1.2

(57) ABSTRACT

Text data corresponding to at least a part of a text contained in the file or picture data corresponding to at least a part of a picture contained in the file is extracted. Thumbnail data to be used as an index thumbnail using the extracted text data or the extracted picture data is generated. An output size of the thumbnail is set by adjusting the output size according to the characteristics of the file from which each thumbnail data is extracted. For each file, an index data is generated by using the thumbnail data of the set output size. The generated index data can be displayed or printed.

### CROSS-REFERENCE TO RELATED APPLICATIONS

This application is a divisional of U.S. patent application Ser. No. 11/679,578, filed Feb. 27, 2007, now pending. The '578 application is a non-provisional application that claims priority under 35 U.S.C. §119(a) to Patent Application No. 2006-054201 filed in Japan on Feb. 28, 2006. Each of these applications is hereby incorporated by reference in their entirety.

### BACKGROUND OF THE INVENTION

1. Field of the Invention

The present invention relates to a data generating apparatus that generates an image data for displaying an index of a file (files) using thumbnails, and a print apparatus equipped with such data generating apparatus for printing the index.

2. Description of Related Art

Print apparatuses such as printer, MFP (Multiple Function Peripheral) include apparatuses having a direct print function of selectively printing a file (files) stored in, when attached, a portable storage medium such as USB (Universal Serial Bus) memory. By such direct print function, a file can be easily and conveniently printed without using an external device such as personal computer to instruct printing. An apparatus having an index print function for reading files from a storage medium and printing on a paper a plurality of images indicating the contents of the files all together in a form of a list is known (see e.g., Japanese Patent Application Laid-Open No. 2005-349822). Using such index print function, the user is able to intuitively select a file (files) desiring to print from a great number of files stored in the storage medium through the use of the index print function.

The user is able to find the intended file by checking the content of the file by index print. The user then operates an operation panel arranged on the print apparatus to select the file desiring to print by designating the file name and the like, and executes direct print of the selected file.

However, the thumbnails are sometimes reduced in excess, too dark, so that the content of the thumbnails may be difficult to recognize depending on the type (document size, format, color etc.) of data. Thus, the intended file may not be specified even if the index is printed using the thumbnails.

### BRIEF SUMMARY OF THE INVENTION

In view of the above, the present invention aims to provide a data generating apparatus for generating data in which an index where the contents of the thumbnails are easy to recognize irrespective of the type etc. of the data contained in the file can be displayed or printed. The present invention also aims to provide a print apparatus equipped with such data generating apparatus capable of printing an index.

The data generating apparatus of the present invention for solving the above problem is characterized by comprising: an extracting unit that extracts, from a file, text data corresponding to at least a part of a text contained in the file or picture data corresponding to at least a part of a picture contained in the file; a thumbnail data generating unit that generates thumbnail data to be used in a thumbnail for an index using the text data or the picture data extracted by the extracting unit; a thumbnail size setting unit that sets a size of the thumbnail by adjusting the size according to the characteristics of the file from which each thumbnail data is extracted; and an index data generating unit that generates an index data for outputting thumbnail data corresponding to each file as the thumbnail for the index at the size set by the thumbnail size setting unit.

Also, the print apparatus according to the present invention, is a print apparatus that prints the index data generated by such data generating apparatus.

According to the data generating apparatus of the present invention, the size of the thumbnail of each file is set to the size corresponding to the characteristics of the file, and the thumbnails are outputted as index at the set output size. Therefore, the index is outputted (displayed or printed) with the thumbnails having an easily recognizable size corresponding to the characteristics of the file, whereby the user can easily find the intended file by looking at the index.

Also, according to the print apparatus of the invention, the index can be printed on the printing paper.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing an inner configuration example when a print apparatus according to the present invention is applied to an MFP (Multiple Function Peripheral);

FIG. 2 is a view showing an example of programs stored in a ROM;

FIG. 3 is a flow chart of a main routine showing the procedures of the index data generating process by an index data generating function (function of index data generating apparatus according to the present invention) of the MFP serving as a print apparatus according to the present invention;

FIG. 4 is a flowchart of a subroutine showing a procedure of a setting process of the output size (thumbnail size) of the thumbnail according to the present invention;

FIG. 5A and FIG. 5B is a flowchart of a subroutine showing a procedure of an arrangement change of the thumbnail according to the present invention;

FIG. 6 is an explanatory view of output example of the index according to the present invention;

FIG. 7 is an explanatory view of output example of the index according to the present invention;

FIG. 8 is an explanatory view of output example of the index according to the present invention; and

FIG. 9 is an explanatory view of output example of the index according to the present invention.

### DETAILED DESCRIPTION OF THE PRESENT INVENTION

The embodiments of the present invention will now be described with reference to the drawings.

### Embodiment 1

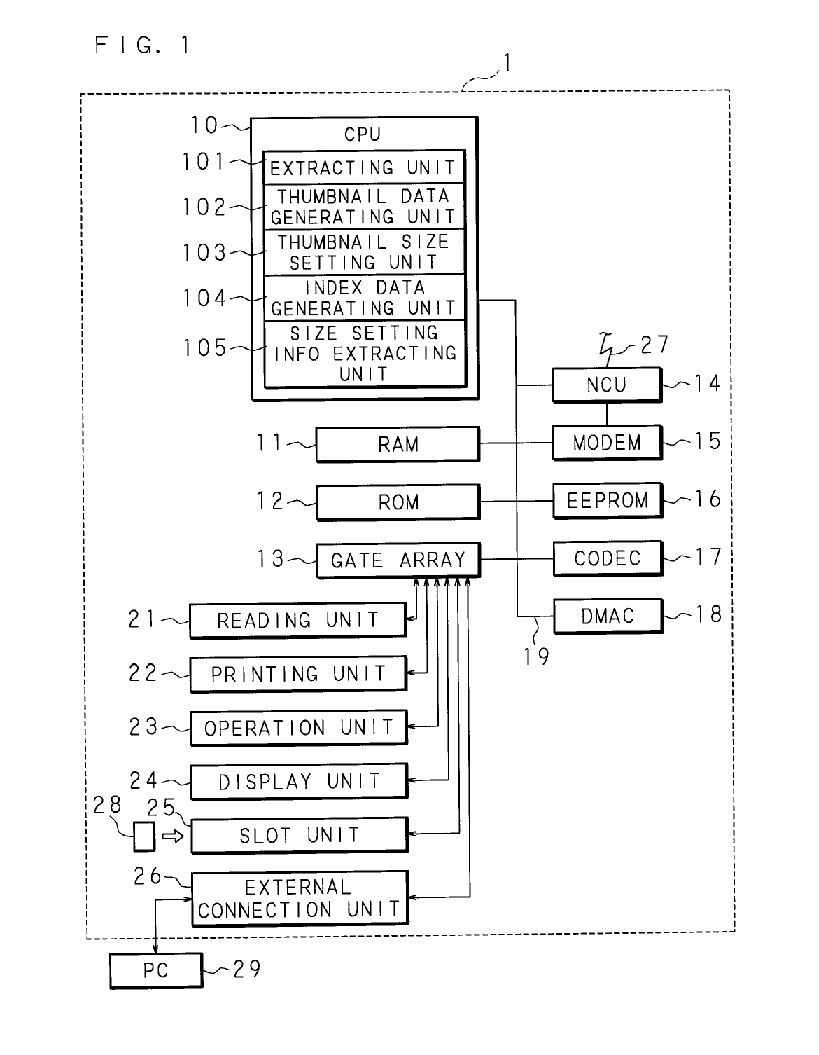

FIG. 1 is a block diagram showing an inner configuration example in a case where a print apparatus of the present invention is applied to an MFP (Multiple Function Peripheral). The MFP 1 serving as the print apparatus of the present invention also has a function serving as a data generating apparatus according to the present invention.

MFP 1 is configured by a CPU 10, a RAM 11, a ROM 12, a gate array 13, an NCU (Network Control Unit) 14, a modem 15, an EEPROM 16, a codec 17, a DMAC (Direct Memory Access Controller) 18 and the like. These components are connected to each other by a bus line 19. The bus line 19 includes an address bus, a data bus, and a control signal line. A reading unit 21, a printing unit 22, an operation unit 23, a displaying unit 24, a slot unit 25, an external connection unit 26 and the like are connected to the gate array 13. A PSTN 27 is connected to the NCU 14.

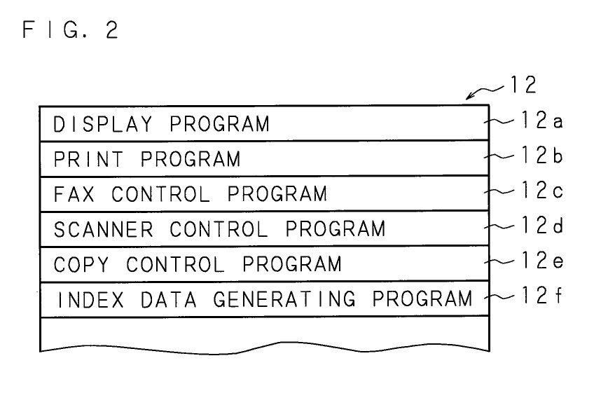

The CPU 10 controls the operation of the entire MFP 1. As shown in FIG. 2, various programs such as display program 12a, print program 12b, FAX control program 12c, scanner control program 12d, copy control program 12e, index data generating program 12f and the like are stored in the ROM 12.

The display program 12a is a program for displaying file name, image (print image) and the like on the displaying unit 24. The print program 12b is a program for controlling the printing unit 22 and performing printing. The index data generating program 12f is a program for generating index data for displaying a plurality of images all together in a form of a list on one screen or on a plurality of screens, that is, for displaying a so-called index. The index data generated by the index data generating program 12f can be displayed on the displaying unit 24 through the display program 12a, or may be printed on a printing medium (normally printing paper, transparent sheet for OHP and the like) by controlling the printing unit 22 through the print program 12b.

The CPU 10 reads and executes the display program 12a, the print program 12b and the index data generating program 12f to functions as an extracting unit 101, a thumbnail data generating unit 102, a thumbnail size setting unit 103, an index data generating unit 104, a size setting information extracting unit 105 and the like of the present invention.

The FAX control program 12c, the scanner control program 12d, and the copy control program 12e stored in the ROM 12 are programs for controlling the FAX function, scanner function and copy function of the MFP 1.

The NCU 14 is connected to the MFP 1. The NCU 14 performs network control such as line connection/disconnection with respect to a public switched telephone network (PSTN) 27.

The RAM 11 is used as a line buffer memory for working area of the CPU 10, expansion area and the like of the read picture.

The modem 15 performs modulation, demodulation and the like of the facsimile data.

The ROM 12 also stores data of various set values and the like necessary for executing the programs, in addition to each program shown in FIG. 2.

The EEPROM 16 stores various flags, setting information and the like necessary for executing each program described above.

The codec 17 performs coding the facsimile data of the picture data and decoding which is the opposite of coding.

The DMAC 18 mainly performs write and read of data to the RAM 11 without through the CPU 10, that is, controls the so-called direct memory access function.

The gate array 13 functions as an input/output interface between the CPU 10 and each unit such as the reading unit 21.

The reading unit 21 includes an image sensor, an LED light source and the like, and reads images of characters and/or figures from a document.

The printing unit 22 prints images of characters and/or figures on a printing paper through an appropriate method such as inkjet method, thermal transfer method.

The operation unit 23 functions as an accepting unit, and includes a key switch group such as ten key, character key. The operation unit 23 accepts the key operation by the user on the key switch group, and to the CPU 10, gives a signal corresponding to the accepted key operation. The operation unit 23 also includes a direct print key to be hereinafter described.

The displaying unit 24 includes a display panel such as an LCD for displaying the operation state of the MFP1, an operation guidance for the user and the like. The displaying unit 24 also displays the index data generated by the index data generating program 12f, as hereinafter described.

The slot unit 25 includes a plurality of types of connectors for connecting various types of storage medium 28 such as smart medium, compact flash®, USB memory. To each connector, the storage medium 28 of the corresponding type can be inserted and removed. Therefore, the slot unit 25 has a function serving as a reader/writer for reading and writing data with respect to the storage medium 28.

The external connection unit 26, which includes connection ports corresponding to standards such as Centronics parallel interface or USB, exchanges data and signal with the personal computer (PC) 29.

The MPF 1 as the print apparatus according to the present invention having above configuration performs data operation process such as transferring the data stored in the storage medium 28 attached to the slot unit 25 to the PC 29 or deleting the data in response to the access from the PC 29. The MFP 1 can perform read and write on different types of storage medium 28 attached to the slot unit 25.

In addition to the function of printing the data in response to the instruction from the PC 29 as a peripheral device of the PC 29, the MFP 1 has a function of reading the data from the storage medium 28 and directly printing the relevant data, that is, a so-called direct print function when the storage medium 28 storing pictures photographed by the digital camera and the like is attached to the slot unit 25. For displaying or printing, the MFP 1 outputs a thumbnail 33 of the file stored in the storage medium 28, for example, the file of the PDF (Portable Document Format) format developed by Adobe Systems Incorporated and/or the graphics file of the JPEG and the like

More specifically, the MFP 1 sets to one of the plurality of output sizes set in advance by adjusting the output size of the thumbnail 33 according to the respective characteristics with respect to each file, and generates unit index data correspondingly with file specifying information, which is the information specifying each file. The size of the thumbnail 33 is adjusted according to the size setting information such as format, brightness, data size etc. of the file by the setting of the size of the thumbnail 33, and thus the index using the thumbnail 33 becomes easier to see.

Therefore, the MFP 1 outputs the thumbnail 33 of each file as index at the size set based on the size setting information, whereby the user is able to easily find the intended file merely through visual checking.

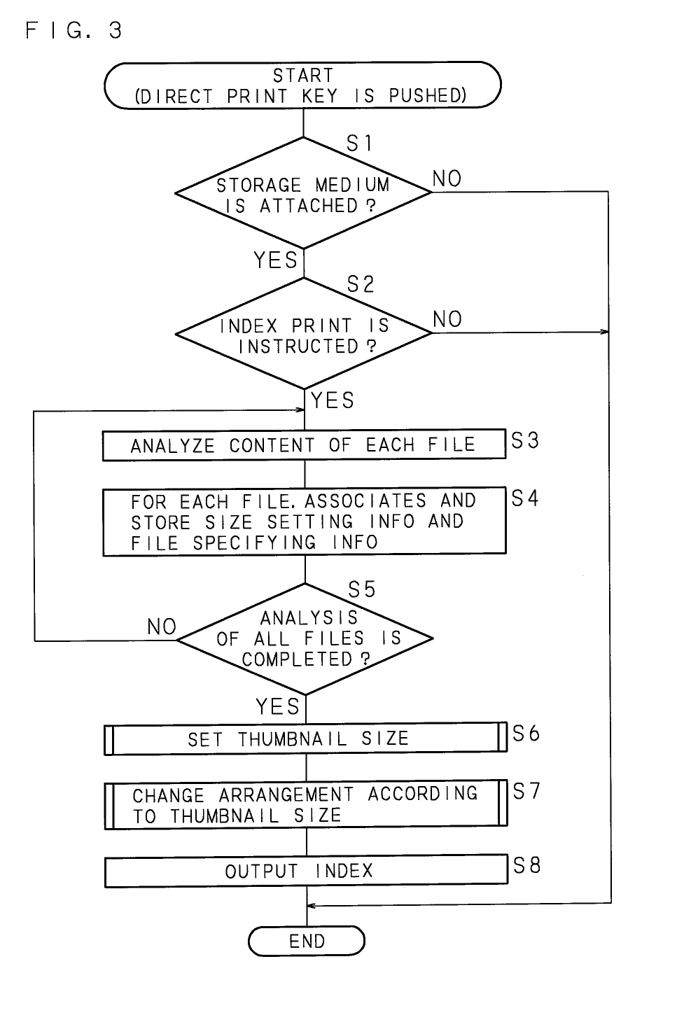

The procedure of the index data generating process by the index data generating function (function of index data generating apparatus according to the present invention) of the MFP 1 as the print apparatus according to the present invention will now be described with reference to a main routine of a flow chart of FIG. 3. The generating process of the index data is executed according to the instruction by the user for the user to search for and select the intended file when direct print of the file stored in the storage medium 28 and the like. The MFP 1 can display the generated index data on the displaying unit 24 as index image, and the index image displayed on the displaying unit 24 can be printed on an appropriate printing paper by the printing unit 24.

When the user pushes the direct print key in the key switch group of the operation unit 23 of the MFP 1, the CPU 10 of the MFP 1 executes the index data generating process according to the procedures of the flow chart of FIG. 3, prior to printing the file for direct print of the file stored in the storage medium 28.

First, the CPU 10 of the MFP 1 judges whether or not the storage medium 28 is attached to the slot unit 25 (step S1). When the storage medium 28 is not attached (step S1: NO), the file to be direct printed is not present, and thus the CPU 10 terminates the process.

When the storage medium 28 is attached to the slot unit 25 (step S1: YES), the CPU 10 monitors whether or not the instruction for index print given by the user is accepted (step S2). When the instruction of index print is not accepted (S2: NO), the process of index print is not performed. For example, index print is not necessary when all the files are to be printed. On the other hand, when index print is instructed (step S2: YES), the CPU 10 executes the index data generating program 12f according to the accepted instruction and executes the following processes.

First, the CPU 10 sequentially analyzes the content of each file stored in the storage medium 28 in a predetermined order (step S3). For each file from the result of analysis, the CPU 10 associates and stores in the memory (RAM 11) the information indicating the presence of pictures and the information indicating the presence of text, and the file specifying information (size, number of pages and the like) specifying each file (step S4).

The CPU 10 then judges whether or not the analysis of all the files stored in the storage medium 28 attached to the slot unit 25 is completed (step S5). When the analysis of all the files is not completed (step S5: NO), the CPU 10 returns the process to step S3 and repeats the processes of step S3 and S4 described above.

When analysis of all the files is completed (step S5: YES), the CPU 10 sets the output size (thumbnail size) of the thumbnail 33 by the size setting information of each file.

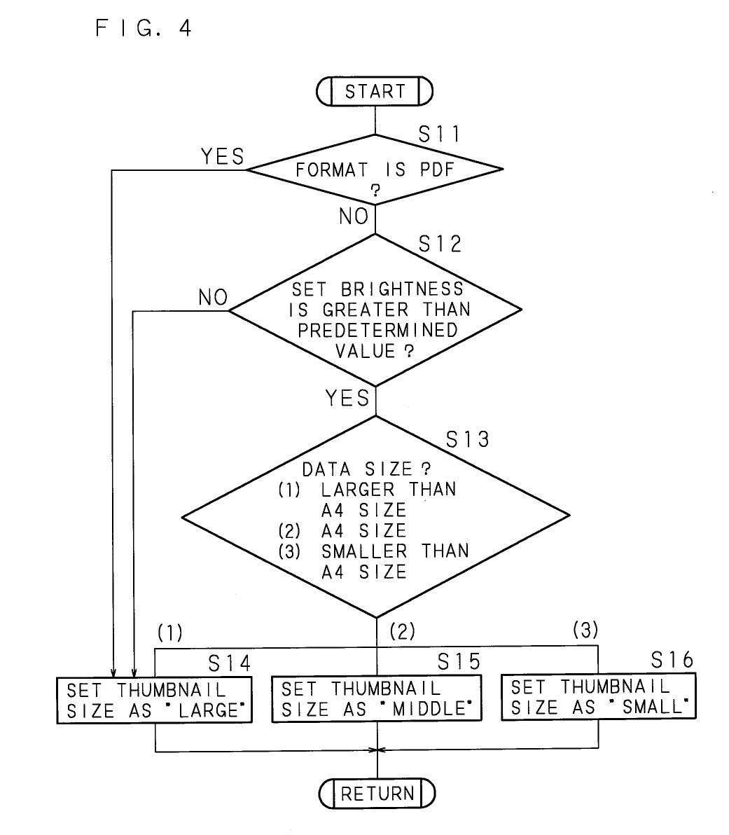

The setting process of the output size (thumbnail size) of the thumbnail 33 at step S6 is executed according to a flow chart of a subroutine shown in FIG. 4. Hereinafter, the description will be made with reference to the flow chart of FIG. 4. In the present embodiment, three types of output size of “large”, “middle” and “small” are set in advance as the size of the thumbnail 33.

First, the CPU 10 judges whether or not the format of the file is the PDF (step S11). When the format of the file is the PDF (step S11: YES), the CPU 10 sets the thumbnail size as “large” (step S14). A predetermined standard size of “middle” is stored in advance in the ROM 12 as the size of the standard thumbnail 33.

When the format of the file is the PDF as described above, generally, a great amount of characters are contained in the file. The visibility of the thumbnail 33 of the file of the PDF format can be improved by making the thumbnail size to be as “large”, which is a size larger than “middle” of the predetermined standard size. At that time, application information for specifying the application by which the file is created is used as the size setting information for determining the size of the thumbnail 33. The size of the thumbnail 33 is set to “large” when the application specified by the application information is document data creating application such as the PDF format. For example, since the application by which the file is created can be specified by header information or extension of the file, such information can be used as the application information.

As described above, the size (thumbnail size) of the thumbnail 33 is set to “large” with regard to files created by the document data creating application so that the visibility of the thumbnail 33 is improved. In the above example, the file of the PDF format is given by way of example as the file created by the document data creating application, but may be files created by various other word processor softwares and the like.

When the format of the file is not the PDF (step S11: NO), that is, when the file is a graphics file, the CPU 10 calculates the average set brightness of the file, and judges whether or not the calculated set brightness is greater than a predetermined value (step S12). When the calculated set brightness is not greater than the predetermined value, that is, when the color of the file is not bright (step S12: NO), the CPU 10 sets the thumbnail size to “large” (step S14).

When the average set brightness of the file is smaller than the predetermined value, the thumbnail image of the file of dark color becomes difficult to distinguish, as described above. However, the visibility of such file can be improved by setting the thumbnail size of such file to “large”, as described above.

On the other hand, when the set brightness is greater than or equal to the predetermined value, that is, when the color of the file is bright (step S12: YES), the CPU 10 judges the data size of the file (step S13). As a result, when the data size of the file is larger than A4 size (step S13: (1)), the CPU 10 sets the thumbnail size to “large” (step S14). When the data size of the file is A4 size (step S13: (2)), the CPU 10 sets the thumbnail size to “middle” (standard output size) (step S15). When the data size of the file is smaller than A4 size (step S13: (3)), the CPU 10 sets the thumbnail size to “small” (step S16). After setting the thumbnail size in the above manner, the CPU 10 returns the process to the main routine shown in the flow chart of FIG. 3.

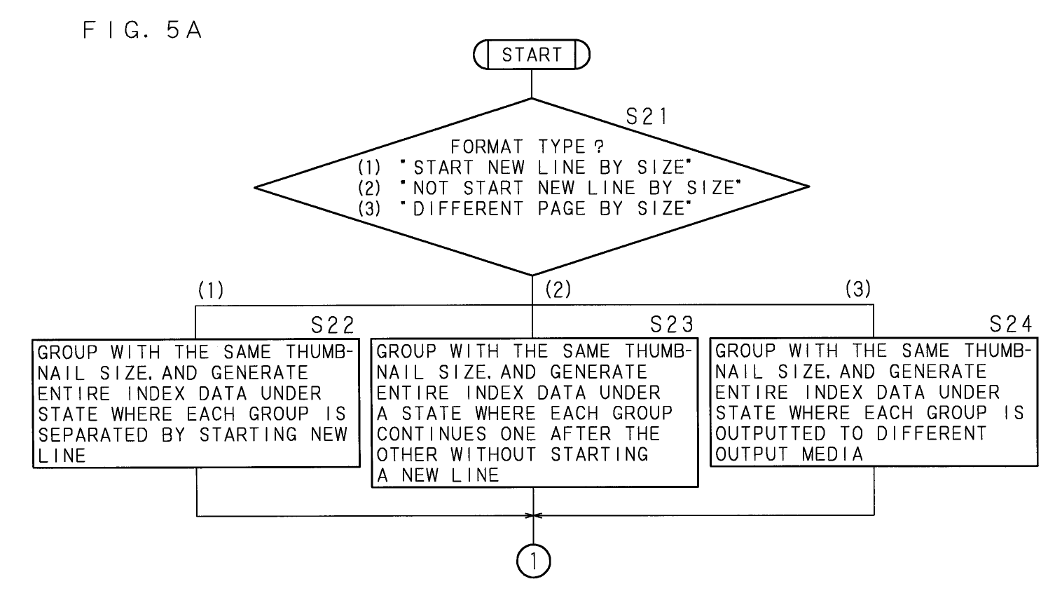

After returning from the subroutine of step S6, the CPU 10 changes arrangement of the thumbnails according to the respective size, that is, changes the format of the index (step S7). The process of arrangement change of the thumbnail of step S7 is executed according to a flow chart of a subroutine shown in FIG. 5A and FIG. 5B. Hereinafter, the description is given with reference to the flow chart of FIG. 5A and FIG. 5B. In the present embodiment, three types of formats of “start new line by size”, “not start new line by size” and “different page by size” are prepared in advance as formats (format of index) of the arrangement of the thumbnail.

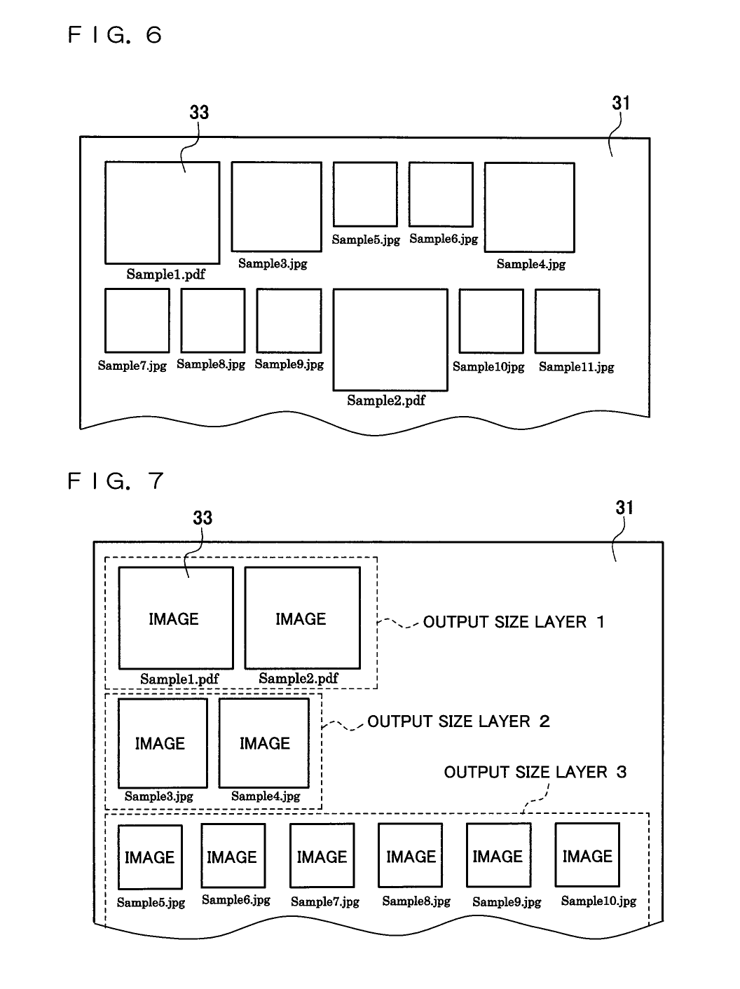

First, the CPU 10 displays a predetermined selection screen (not shown) on a displaying unit 24 to urge the user to select a format of the index. When the user selects the format of “start new line by size” with reference to the selection screen (step S21: (1)), the CPU 10 groups the unit index data with the same thumbnail size. Then, the CPU 10 generates entire index data in which each unit index data is arranged in the order from the group of smallest thumbnail size, under a state where each group is separated by starting a new line (step S22). The output example of the index for this case is as shown in FIG. 7.

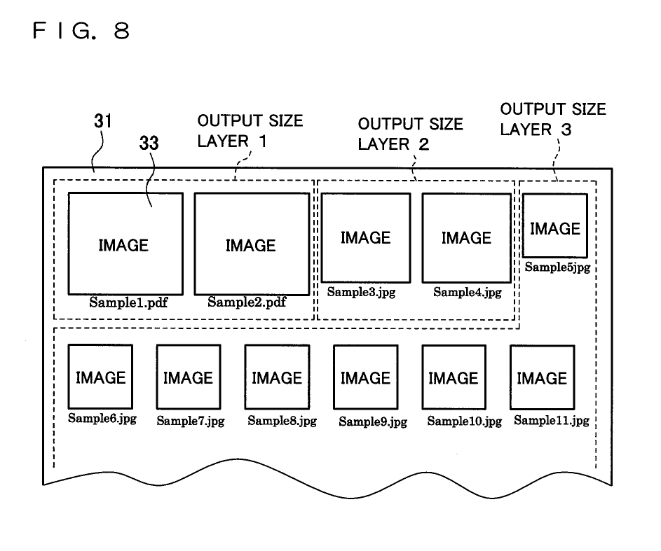

When the user selects the format of “not start new line by size” (step S21: (2)), the CPU 10 groups the unit index data with the same thumbnail size. Then, the CPU 10 generates entire index data in which each unit index data is arranged in the order from the group of smallest thumbnail size, under a state where each group continues one after the other without starting a new line (step S23). The output example of the index for this case is as shown in FIG. 8.

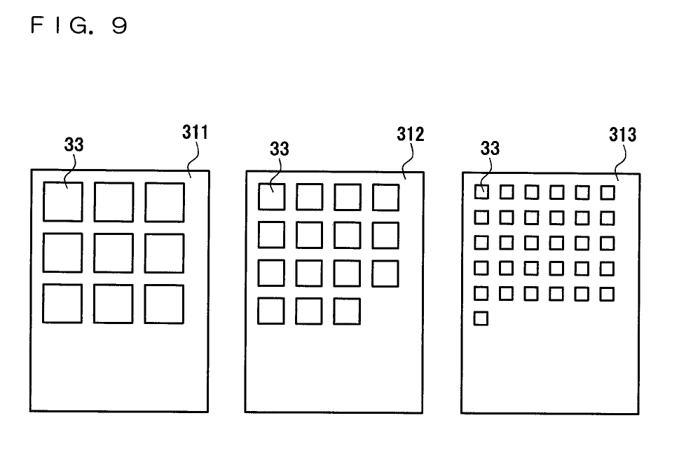

When the user selects the format of “different page by size” (step S21: (3)), the CPU 10 groups the unit index data with the same thumbnail size. Then, the CPU 10 generates entire index data in which each unit index data is arranged in the order from the group of smallest thumbnail size, under a state where each group is outputted to different output media (plurality of display screens displayed on the displaying unit 24 or different printing paper) (step S24). The output example of the index for this case is as shown in FIG. 9.

The CPU 10 judges whether or not whole of the generated entire index data can be displayed on the screen of the displaying unit 24 or can be printed on one side of the printing paper 31 of A4 size, for example, usually used in the printing unit 22 (step S25). When whole of the generated entire index data can be displayed on the screen of the displaying unit 24, or can be printed on one side of the printing paper 31 of A4 size (step S25: YES), the CPU 10 returns the process to the main routine (step S7) of the flow chart of FIG. 3. However, when whole of the generated entire index data cannot be displayed on the screen of the displaying unit 24, or cannot be printed on one side of the printing paper 31 of A4 size (step S25: NO), the CPU 10 sets to display the entire index data on the screen of the displaying unit 24 by scrolling or to print on a plurality of printing papers (may be two-sided printing) by the printing unit 22 (step S26). Thereafter, the CPU 10 returns the process to the main routine shown in the flow chart of FIG. 3.

When returning from the subroutine of step S6 to the main routine of FIG. 3, the entire index data of the thumbnails corresponding to the thumbnail size, in other words, in which the arrangement change of the unit index data is completed according to the process of step S7 is generated. Therefore, the CPU 10 outputs (displays or prints) the index based on the generated entire index data (step S8).

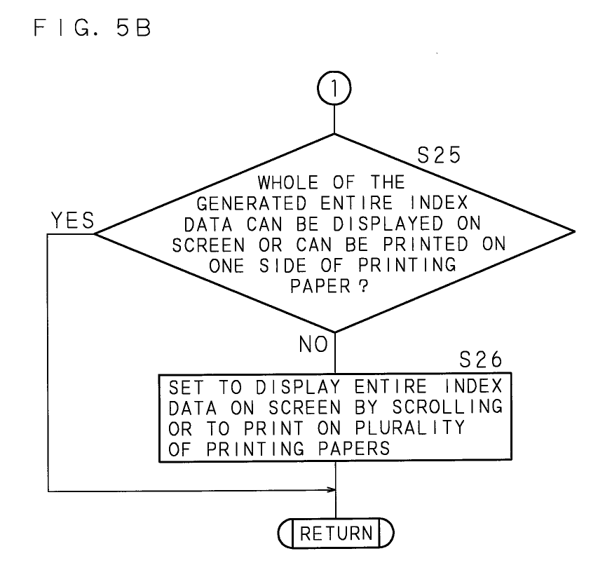

Output examples of the index will now be described with reference to FIG. 6, FIG. 7, FIG. 8 and FIG. 9.

FIG. 6 shows an example in which the thumbnails 33 set with three output sizes of “large”, “middle” and “small” are displayed as index on the screen of the displaying unit 24 or printed as index on the printing paper 31 after adjusting the thumbnail size according to the characteristics of the file. It is noted that the example shown in FIG. 6 is not in a changed state of the arrangement according to the output size of each thumbnail 33. Such state is an output example of when step S7 (i.e., process according to the subroutine of FIG. 5A and FIG. 5B) of FIG. 3 is omitted. When arrangement change according to the output size of the thumbnail at step S7 of FIG. 3 is performed, output (display or print) is performed with the thumbnails 33 grouped by size, as shown in FIG. 7, FIG. 8, and FIG. 9.

FIG. 7 shows an output example in which the thumbnail sizes are sorted in output size layers 1, 2, and 3. The thumbnail 33 of “large” size is grouped in the output size layer 1, the thumbnail 33 of “middle” size in the output size layer 2, and the thumbnail 33 of “small” size in the output size layer 3, and furthermore, the thumbnails 33 are displayed on the screen of the displaying unit 24 or printed on the printing paper 31 starting a new line with respect to each output size layer. Such state is an example of the output of when (1) “start new line by size” is selected at step S21 of FIG. 5A. Below each thumbnail 33, the file name added as the file specifying information is outputted.

Therefore, the user can executes direct print of the intended file by inputting directly on the screen of the displaying unit 24 or by inputting the file name displayed on the printed index through operation of the operation unit 23. In addition to the file name, file size, number of pages etc. may be outputted as the file specifying information.

FIG. 8 shows an output example in which the thumbnail sizes are sorted in output size layers 1, 2, and 3. This is the same as the example of FIG. 7 in that the thumbnail 33 of “large” size is grouped in the output size layer 1, the thumbnail 33 of “middle” size in the output size layer 2, and the thumbnail 33 of “small” size in the output size layer 3, but each output size layer is continuously outputted without starting a new line with respect to each output size layer. Such state is an example of the output of when (2) “not start new line by size” is selected at step S21 of FIG. 5A. More large number of thumbnails 33 can be outputted as an index on the screen of the displaying unit 24 or on one piece of printing paper 31 according to such output state.

FIG. 9 shows an example displayed on a plurality of display screens displayed on the screen of the displaying unit 24 or outputted to different printing papers 31 with respect to each output size layer. That is, the thumbnail 33 whose thumbnail size is “large”, the thumbnail 33 whose thumbnail size is “middle”, and the thumbnail 33 whose thumbnail size is “small” are displayed on different display screens displayed on the screen of the displaying unit 24 or printed on different printing papers 311, 312, 313 by the printing unit 22, respectively. Such state is an example of the output of when (3) “different page by size” is selected at step S21 of FIG. 5A. In the example shown in FIG. 9, the output of the file name, that is, the file specifying information of each thumbnail 33 is omitted.

Examples in which the output size layers are sorted into three stages have been shown in the above examples, but may obviously be sorted into two stages, or four or more stages. The size of the thumbnail 33 may be set not by the output size layer, that is, by sorting into stages but proportionally according to the data size of the file, and each thumbnail 33 may be arranged in the order of size according to the set size, for example, in the order from thumbnail of large size to thumbnail of small size. On the contrary, the thumbnails may be arranged in the order from thumbnail of small size to thumbnail of large size. The visibility is improved by arranging the thumbnails 33 according to the thumbnail size.

According to the present invention, the size of the thumbnail 33 is adjusted according to the characteristics of the file, and each thumbnail 33 is displayed or printed as an index in the arrangement based on the adjusted size, whereby the user can easily find the intended file from the index output.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds there-of are therefore intended to be embraced by the claims.

What is claimed is:

1. An index output apparatus, comprising:
a storing unit configured to store plural files including a file generated in a text format and a file generated in a picture format; and
a processor configured to control the apparatus to provide:
an index output unit that is configured to output an index on which plural thumbnails based on the plural files stored by the storing unit are arranged,
wherein, in the index output by the index output unit, an output size of a thumbnail based on the file generated in the text format, among the plural thumbnails, is larger than an output size of a thumbnail based on the file generated in the picture format, among the plural thumbnails.

2. The index output apparatus according to claim 1, wherein
the text format is a PDF format, and
the picture format is a JPG format.

3. The index output apparatus according to claim 1, wherein
the index output by the index output unit comprises a first area and a second area,
thumbnails having large output sizes among the plural thumbnails are serialized in the first area, and
thumbnails not having the large output sizes among the plural thumbnails are serialized in the second area.

4. The index output apparatus according to claim 3, further comprising:
an option accepting unit that is configured to accept a selection of an option among plural options including at least a first option and a second option,
wherein, when the option accepting unit accepts to select the first option, the first area and the second area are serialized on the index output by the index output unit, and
wherein, when the option accepting unit accepts to select the second option, the plural thumbnails are arranged in a predetermined order, regardless output sizes of the plural thumbnails, on the index output by the index output unit.

35. The index output apparatus according to claim 4,
wherein the predetermined order is a file name order.

6. The index output apparatus, comprising:
a storing unit that is configured to store plural image files;
a processor configured to control the apparatus to provide:
a set brightness calculating unit that is configured to calculate set brightness of the plural image files stored by the storing unit; and
an index output unit that is configured to output an index on
which plural thumbnails based on the plural image files stored by the storing unit are arranged,
wherein on the index output by the index output unit, an output size of a thumbnail based on an image file whose set brightness calculated by the set brightness calculating unit is not greater than a predetermined value among the plural image files, is larger than an output size of a thumbnail based on an image file whose set brightness calculated by the set brightness calculating unit is greater than the predetermined value among the plural image files.

7. The index output apparatus according to claim 6,
wherein the index output by the index output unit comprises a first area and a second area,
wherein thumbnails having large output sizes among the plural thumbnails are serialized in the first area, and
wherein thumbnails not having the large output sizes among the plural thumbnails are serialized in the second area.

8. The index output apparatus according to claim 7, further comprising:
an option accepting unit that accepts to select an option among plural options including at least a first option and a second option,
wherein, when the option accepting unit accepts to select the first option, the first area and the second area are serialized on the index output by the index output unit, and
wherein, when the option accepting unit accepts to select the second option, the plural thumbnails are arranged in a predetermined order, regardless output sizes of the plural thumbnails, on the index output by the index output unit.

9. The index output apparatus according to claim 8,
wherein the predetermined order is a file name order.

10. A non-transitory computer readable medium including a computer readable program, the computer readable program when executed causes a computer system to execute steps of;
storing plural files which comprise a file generated in a text format and a file generated in a picture format; and
outputting an index on which plural thumbnails based on the stored plural files,
wherein on the output index, an output size of a thumbnail based on the file generated in the text format, among the plural thumbnails, is larger than an output size of a thumbnail based on the file generated m the picture format, among the plural thumbnails.

11. A non-transitory computer readable medium including a computer readable program, the computer readable program when executed causes a computer system to execute steps of;
storing plural image files;
calculating set brightness of the stored plural image files; and
outputting an index on which plural thumbnails based on the stored plural image files,
wherein on the output index, an output size of a thumbnail based on an image file whose calculated set brightness is not greater than a predetermined value among the plural image files, is larger than an output size of a thumbnail based on an image file whose calculated set brightness is greater than the predetermined value among the plural image files.
